(19) United States
(12) Patent Application Publication
(10) Pub. No.: US 2018/0359990 A1
(43) Pub. Date: Dec. 20, 2018

(54) PET TRANSPORT SYSTEMS

(71) Applicant: Philippa Graham, Katy, TX (US)

(72) Inventor: Philippa Graham, Katy, TX (US)

(21) Appl. No.: 16/011,581

(22) Filed: Jun. 18, 2018

Related U.S. Application Data
(60) Provisional application No. 62/521,093, filed on Jun. 16, 2017.

(51) Int. Cl. A01K 1/02; A45F 3/02

(52) U.S. Cl. CPC A01K 1/029; A01K 1/0272; A01K 1/0254; A45F 3/02

(57) ABSTRACT

A convertible pet carrier for a small pet that allows a user to travel with their pet. The apparatus can be carried by hand across the chest or by handles attached to the top. The apparatus includes fold-down walls that allow the device to be fully opened for a pet to lay in as a bed. The apparatus may also be attached to a passenger-car seat to allow the user to transport their pet safely while driving in a vehicle.

### CROSS REFERENCE TO RELATED APPLICATION

The present application is related to and claims priority to U.S. Provisional Patent Application No. 62/521,093 filed 2107 Jun. 16, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of animal husbandry and more specifically relates to hand or body-type carriers for assisting the transport and care of pets.

### 2. Description of Related Art

People often travel with their pets, whether simply to the park for an afternoon outside or on vacation. Unfortunately, pets may feel uncomfortable without a place of their own to sleep and rest. Therefore, pet owners often pack pet beds, which are large and cumbersome, even for smaller animals. Toting a bed around, along with the animal in a carrier, as well as other belongings can be a hassle. Some pet owners may forgo the bed, but their pets may become stressed and uncomfortable, barking and causing a scene. An effective solution is needed.

Prior attempts have been made to overcome the above-noted problem. For example, the U.S. Pat. No. 6,076,485 to Peeples, et al. relates to a pet carrier. The described pet carrier includes a collapsible pet carrier of lightweight construction is disclosed. The endwalls are foldable onto the bottom, with the sidewalls foldable around the endwalls, allowing the straps to hold the bundle together when not in use. The carrier can be quickly assembled by pivoting the endwalls upwardly and fastening them to the sidewalls and securing the handles to each other. An optional storage pouch can be incorporated into the handle system and various windows in the side or endwalls can be provided to facilitate ventilation.

### BRIEF SUMMARY OF THE INVENTION

In view of the foregoing disadvantages inherent in the known animal husbandry art, the present disclosure provides novel pet transport systems. The general purpose of the present disclosure, which will be described subsequently in greater detail, is to provide a carry-on bag that converts into a sleeping mat for pets. Apparatus of the present disclosure alleviates the hassle of packing and transporting large, cumbersome pet beds. This is particularly useful in air travel, which is often subject to restrictions in terms of the size and number of luggage items that may be carried or checked without incurring added fees. Apparatus of the present disclosure further assists in preventing pets from becoming stressed and incessantly barking or causing commotion. Moreover, apparatus of the present disclosure accommodates all types of travel, including by car, ship, and train. The present system ensures pets are safe and comfortable during transport.

An apparatus for transporting a pet is disclosed herein. The apparatus includes a center panel that may have four edges, the four edges may have a first edge and a second edge opposite the first edge, and the four edges further may have a third edge and a fourth edge opposite the third edge, the center panel defining a horizontal plane having a left direction corresponding to the third edge, a right direction corresponding to the fourth edge, a forward direction corresponding to the first edge, and an aft direction corresponding to the second edge. In addition the apparatus includes a first sidewall panel that may have a first forward edge, a first aft edge, a first left edge, and a first right edge, the first aft edge extending from the first edge of the center panel, the first sidewall panel adapted to be movable between a first upright orientation and a first collapsed orientation; a second sidewall panel may have a second forward edge, a second aft edge, a second left edge, and a second right edge, the second forward edge extending from the second edge of the center panel, the second sidewall panel adapted to be movable between a second upright orientation and a second collapsed orientation; a third sidewall panel that may have a third forward edge, a third aft edge, a third left edge, and a third right edge, the third right edge extending from a combination of the third edge of the center panel, at least a portion of the first left edge of the first sidewall panel, and at least a portion of the second left edge of the second sidewall panel together, the third sidewall panel adapted to be movable between a third upright orientation and a third collapsed orientation, the third forward edge and the third aft edge each being configured to fold toward the center panel when the third sidewall panel may be in the third upright orientation, respectively; and a fourth sidewall panel that may have a fourth forward edge, a fourth aft edge, a fourth left edge, and a fourth right edge, the fourth left edge extending from a combination of the fourth edge of the center panel, at least a portion of the first right edge of the first sidewall panel, and at least a portion of the second right edge of the second sidewall panel together, the fourth sidewall panel adapted to be movable between a fourth upright orientation and a fourth collapsed orientation, the fourth forward edge and the fourth aft edge each being configured to fold toward the center panel when the fourth sidewall panel may be in the fourth upright orientation; and wherein the center panel, the first sidewall panel, the second sidewall panel, the third sidewall panel, and the fourth sidewall panel together are configured to form a four-wall, semi-enclosed interior when the first sidewall panel, the second sidewall panel, the third sidewall panel, and the fourth sidewall panel are secured in the first, second, third, and fourth upright orientations, respectively; and wherein the center panel, the first sidewall panel, the second sidewall panel, the third sidewall panel, and the fourth sidewall panel together are configured to form a substantially horizontal pad when the first sidewall panel, the second sidewall panel, the third sidewall panel, and the fourth sidewall panel are opened into the first, second, third, and fourth collapsed orientations, respectively.

A method of using the apparatus is also disclosed herein. The apparatus the method of use including the steps of: securing the pet in a position adjacent the apparatus using the pet-restraining leash; restraining the apparatus in a position adjacent the vehicle seat by forming a looped engagement of the shoulder strap with a headrest of the vehicle seat; restraining the apparatus in a position adjacent the vehicle seat by releasably engaging the seatbelt of the vehicle seat with the external restraint loop of the apparatus. Even further, the method may further include the step of opening at least one of the first sidewall panel, the second sidewall panel, the third sidewall panel, and the fourth sidewall panel from the first, second, third, and fourth upright orientations, respectively, into the first, second, third, or fourth collapsed orientations, respectively, during transport.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a pet transport system, constructed and operative according to the teachings of the present disclosure.

FIG. 1 is a front perspective view of the apparatus, according to an embodiment of the disclosure.

FIG. 2 is a rear perspective view of the apparatus of FIG. 1, according to an embodiment of the present disclosure.

FIG. 3 is a perspective view of the apparatus of FIG. 1 during an ‘in-use’ condition, according to an embodiment of the present disclosure.

FIG. 4 is a perspective view of the apparatus of FIG. 1, according to an embodiment of the present disclosure.

FIG. 5 is a perspective view of the apparatus of FIG. 1 in an opened configuration, according to an embodiment of the present disclosure.

FIG. 6 is a bottom view of the apparatus of FIG. 1, according to an embodiment of the present disclosure.

FIG. 7 is a top view of the apparatus of FIG. 1, according to an embodiment of the present disclosure.

FIG. 8 is a perspective view of the apparatus of FIG. 1 during an alternate ‘in-use’ condition, according to an embodiment of the present disclosure.

FIG. 9 is a flow diagram illustrating a method of use for apparatus, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to an animal husbandry and more particularly to a pet transport system as used to improve the hand or body-type carrier for assisting the transport and care of pets.

Generally, the disclosed system consists of a convertible pet carrier for a small pet that allows a user to travel with their pet. The multi-purpose device provides a comfortable, safe, and efficient way to travel with pets. The pet carrier can be carried by hand across the chest or by handles attached to the top. It may have fold-down walls that allow the device to be fully opened for a pet to lay in as a bed. The pet carrier may also be attached to a passenger-car seat to allow the user to transport their pet safely while driving in a vehicle. The pet carrier may also be attached to an airline seat to allow the pet to sit next to the owner while flying long distances. The multipurpose apparatus may also be used during outdoor activities were an easily-transportable sleeping mat is needed.

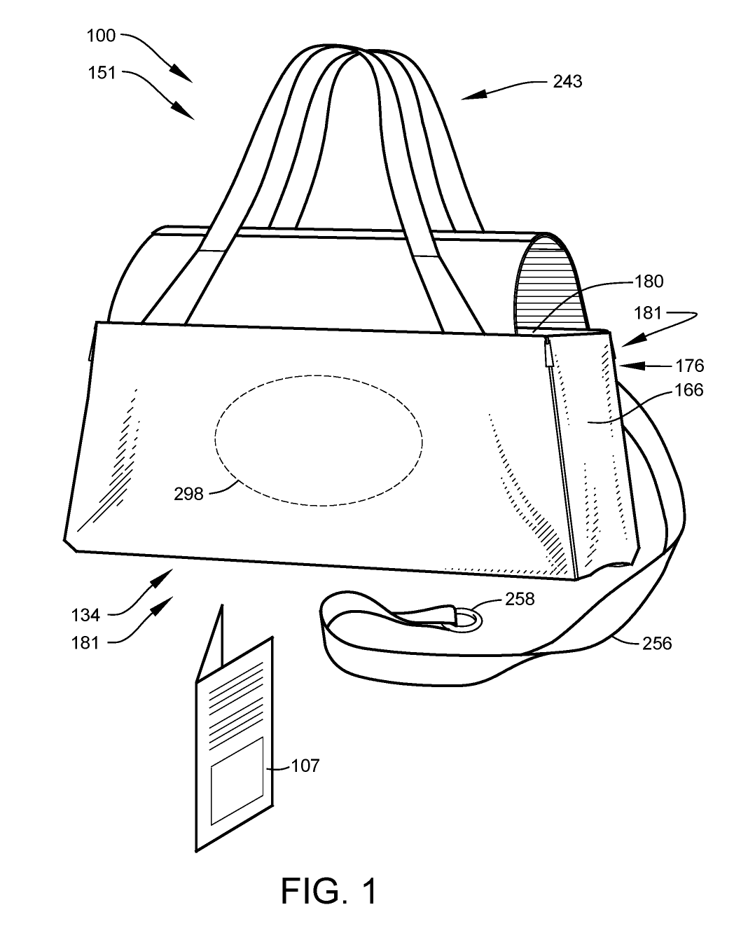

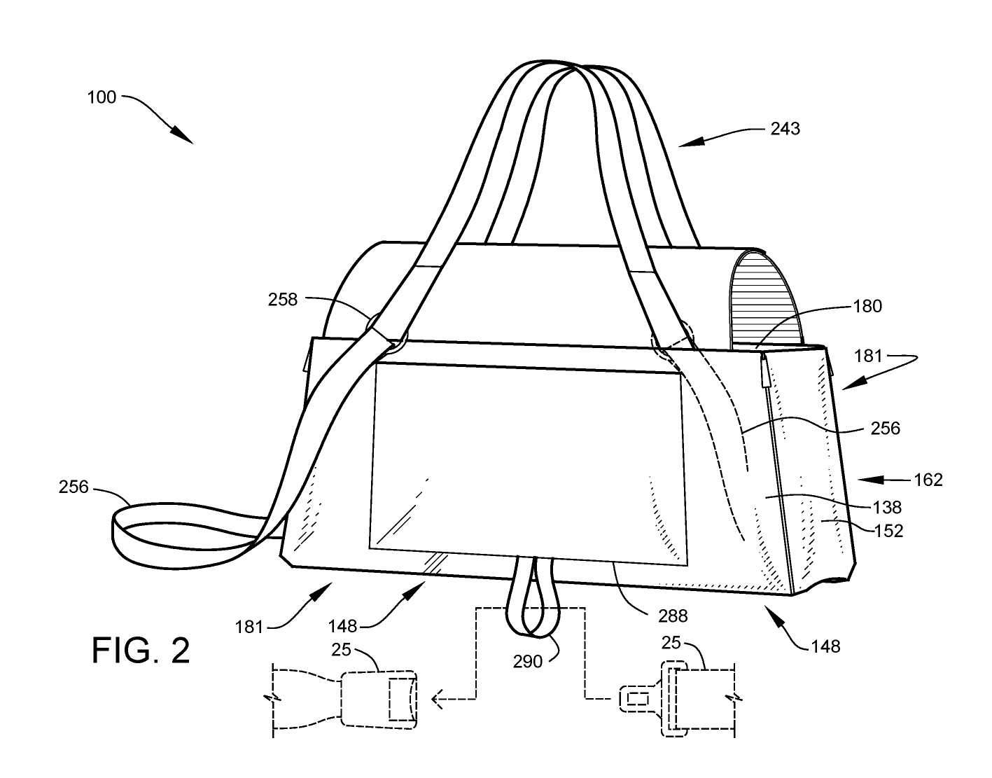

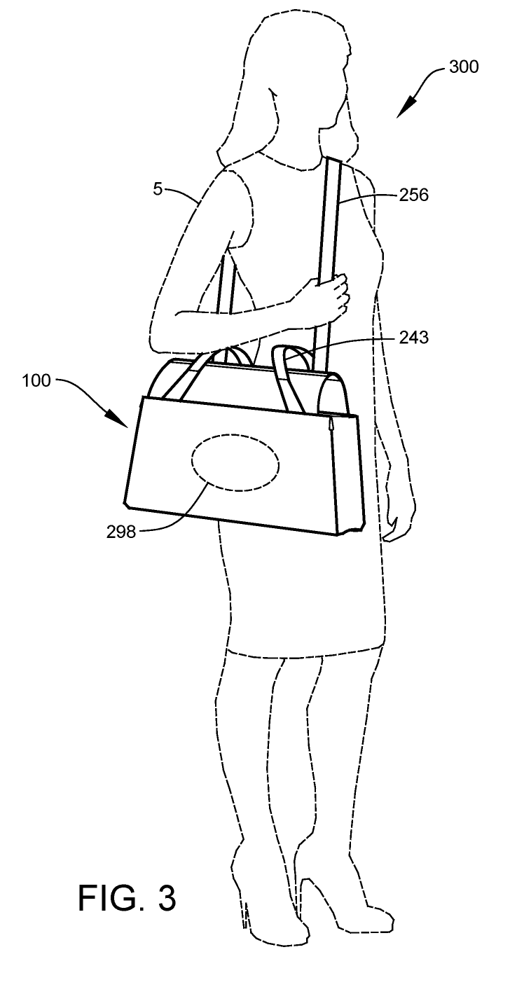

Referring now more specifically to the drawings by numerals of reference, there is shown in FIGS. 1-8, various views of a pet transport apparatus 100 according to an embodiment of the present disclosure. FIG. 1 is a front perspective view of the pet transport apparatus 100. FIG. 2 is a rear perspective view of the pet transport apparatus 100 of FIG. 1. FIG. 3 is a perspective view of pet transport apparatus 100 of FIG. 1 during an ‘in-use’ condition 300.

The pet transport apparatus 100 may be arranged as a soft-sided storage container to assist a user 5 in transporting a pet, items related to the pet, or both. In addition, the pet transport apparatus 100 is readily convertible into a flattened pad, which may function as a bed for the pet.

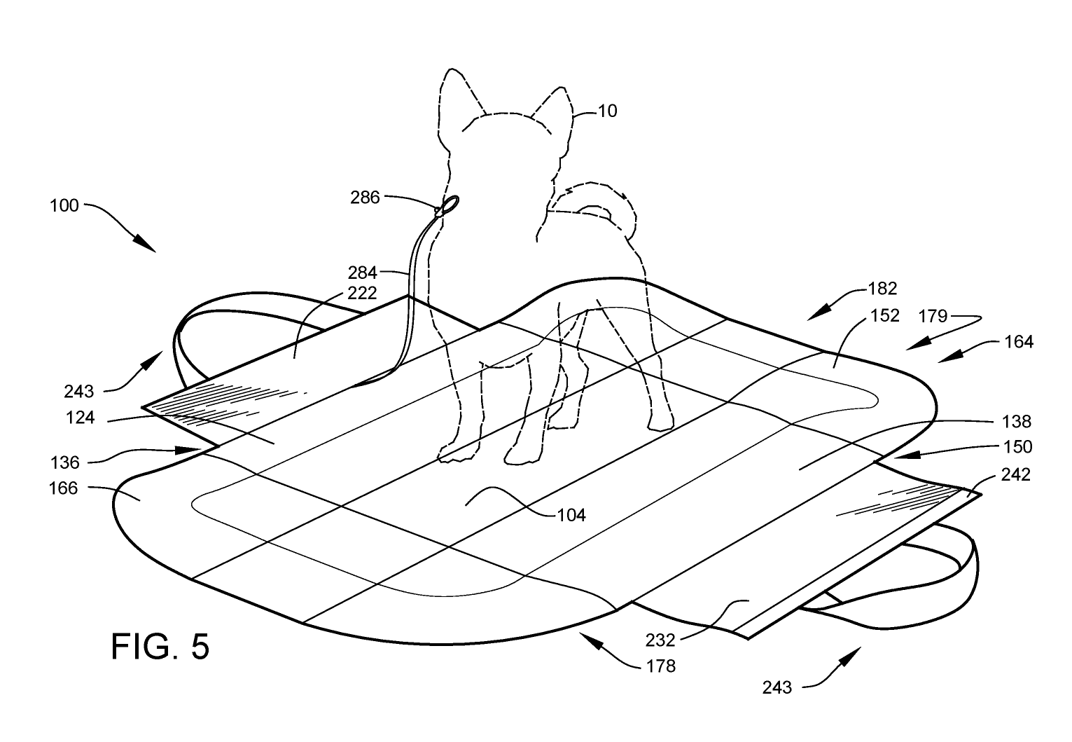

As illustrated, the pet transport apparatus 100 includes a set of side-wall panels 101 that may be selectively folded downward to transform the container into the flattened pad illustrated in FIG. 5. The pet transport apparatus 100 can be carried by a shoulder strap 256 or by carrying handles 243, as shown. Additionally, the pet transport apparatus 100 may include one or more exterior pockets 288 for the storage of accessory items.

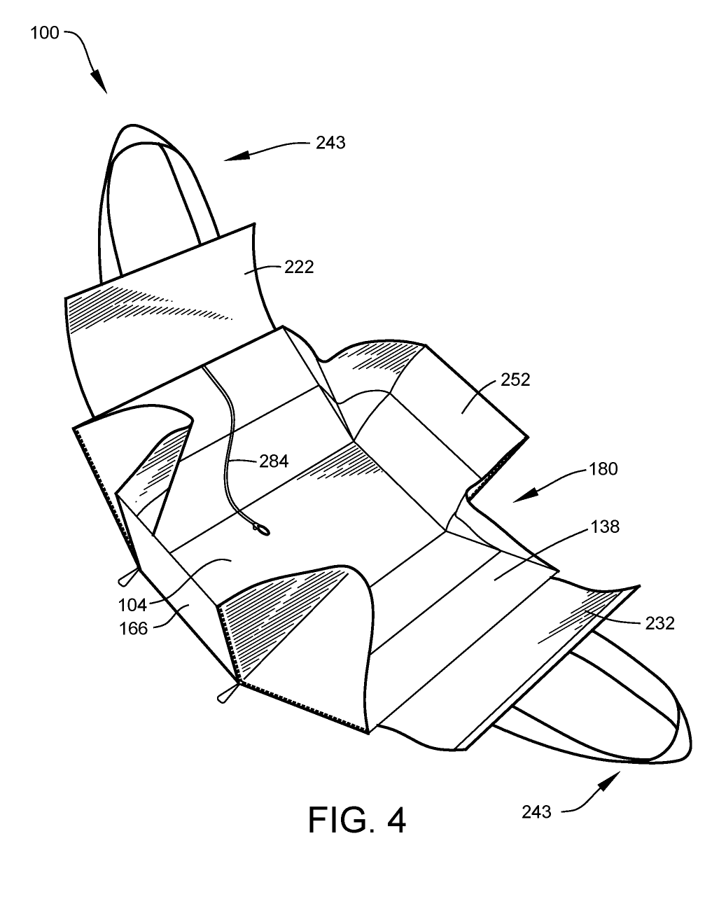

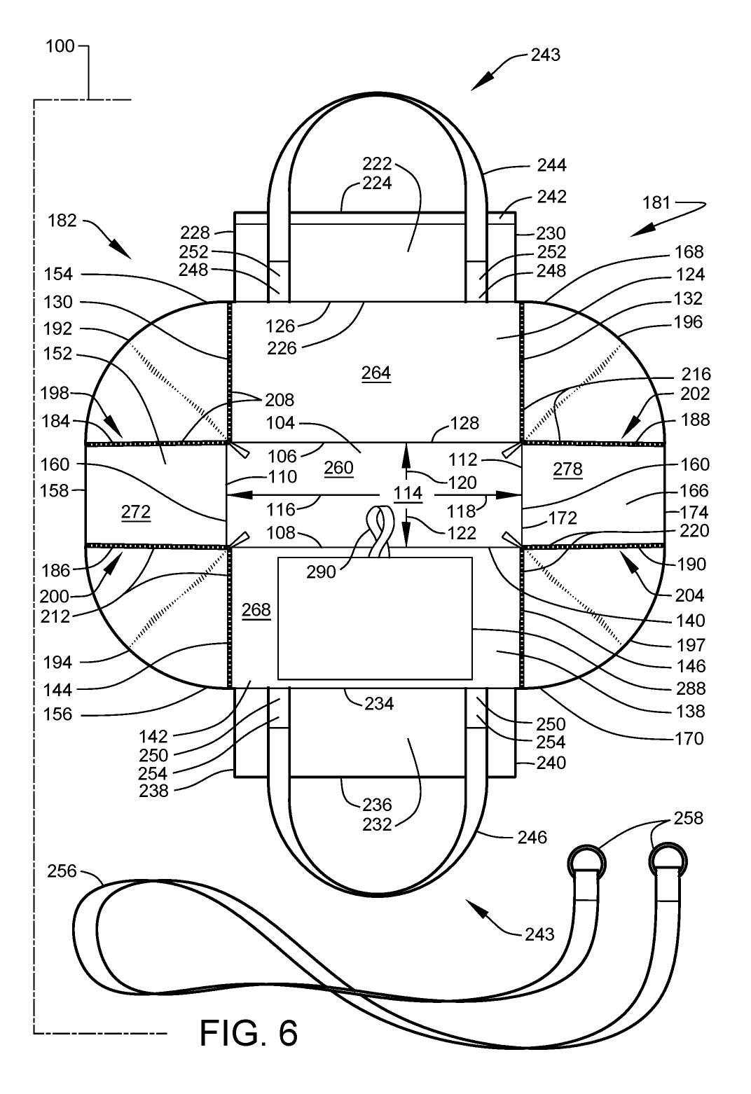

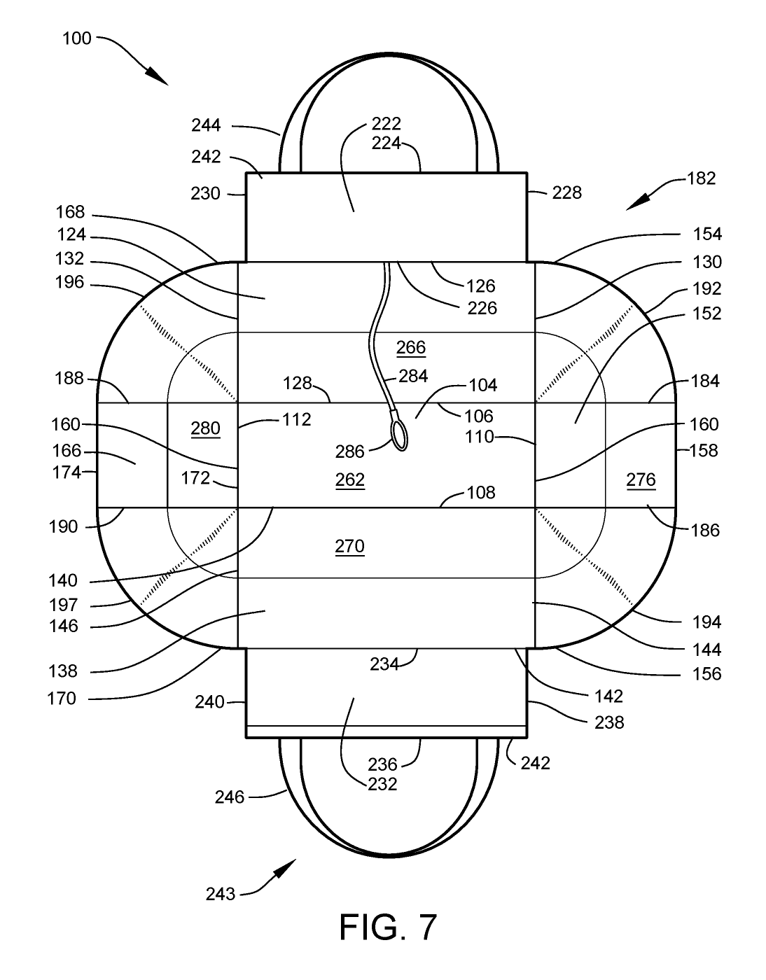

FIG. 4 is a perspective view of the pet transport apparatus 100 of FIG. 1 in a partially-opened configuration, according to an embodiment of the present disclosure. FIG. 5 is a perspective view of the pet transport apparatus 100 of FIG. 1 in a fully opened configuration forming the substantially horizontal pad 182 noted above. FIG. 6 is a bottom view of the pet transport apparatus 100 of FIG. 1 in the fully opened configuration. FIG. 7 is a top view of the pet transport apparatus 100 of FIG. 1 in the fully opened configuration.

In reference to FIG. 4 through FIG. 7, the pet transport apparatus 100 may include a center panel 104 having four edges, such four edges having a first edge 106 and a second edge 108 opposite the first edge 106. Such four edges may further have a third edge 110 and a fourth edge 112 opposite the third edge 110, the center panel 104 defining a horizontal plane 114 having a left direction 116 corresponding to the third edge 110, a right direction 118 corresponding to the fourth edge 112, a forward direction 120 corresponding to the first edge 106, and an aft direction 122 corresponding to the second edge 108. In addition, the pet transport apparatus 100 includes a first sidewall panel 124 having a first forward edge 126, a first aft edge 128, a first left edge 130, and a first right edge 132, the first aft edge 128 joined to and extending from the first edge 106 of the center panel 104, as shown. The first sidewall panel 124 may be adapted to be movable between a first upright orientation 134, as shown in FIG. 1, and a first collapsed orientation 136, as shown in FIG. 5.

The pet transport apparatus 100 may also include a second sidewall panel 138 having a second forward edge 140, a second aft edge 142, a second left edge 144, and a second right edge 146, the second forward edge 140 joined to and extending from the second edge 108 of the center panel 104, as shown. The second sidewall panel 138 may be adapted to be movable between a second upright orientation 148, as shown in FIG. 2, and a second collapsed orientation 150, as shown in FIG. 5.

The pet transport apparatus 100 may further include a third sidewall panel 152 having a third forward edge 154, a third aft edge 156, a third left edge 158, and a third right edge 160, the third right edge 160 joined to and extending from a combination of the third edge 110 of the center panel 104, at least a portion of the first left edge 130 of the first sidewall panel 124, and at least a portion of the second left edge 144 of the second sidewall panel 138 together, as shown. The third sidewall panel 152 may be adapted to be movable between a third upright orientation 162, as shown in FIG. 2, and a third collapsed orientation 164, as shown in FIG. 5. In addition, the third forward edge 154 and the third aft edge 156 may each be configured to fold toward the center panel 104 when the third sidewall panel 152 is in the third upright orientation 162, respectively.

The pet transport apparatus 100 may also include a fourth sidewall panel 166 having a fourth forward edge 168, a fourth aft edge 170, a fourth left edge 172, and a fourth right edge 174, the fourth left edge 172 joined to and extending from a combination of the fourth edge 112 of the center panel 104, at least a portion of the first right edge 132 of the first sidewall panel 124, and at least a portion of the second right edge 146 of the second sidewall panel 138 together. The fourth sidewall panel 166 may be adapted to be movable between a fourth upright orientation 176, as shown in FIG. 1, and a fourth collapsed orientation 178, as shown in FIG. 5. The fourth forward edge 168 and the fourth aft edge 170 may each be configured to fold toward the center panel 104 when the fourth sidewall panel 166 is in the fourth upright orientation 176.

In one configuration of the disclosure, the center panel 104, the first sidewall panel 124, the second sidewall panel 138, the third sidewall panel 152, and the fourth sidewall panel 166 together are configured to form a four-wall, semi-enclosed interior 180 when the first sidewall panel 124, the second sidewall panel 138, the third sidewall panel 152, and the fourth sidewall panel 166 are secured in the first, second, third, and fourth upright orientations, respectively (see FIG. 1 and FIG. 2). As illustrated in FIG. 5, the center panel 104, the first sidewall panel 124, the second sidewall panel 138, the third sidewall panel 152, and the fourth sidewall panel 166 together are configured to form a substantially horizontal pad 182 when the first sidewall panel 124, the second sidewall panel 138, the third sidewall panel 152, and the fourth sidewall panel 166 are opened into the first, second, third, and fourth collapsed orientations, respectively.

The pet transport apparatus 100 may be constructed from at least one flexible sheet material. More specifically, the inner surfaces 179 of the semi-enclosed interior 180 (and the substantially horizontal pad 182) may be constructed from a soft padded material, whereas the exterior surfaces 181 can be made from a durable nylon, plastic, or other suitable material.

Moreover, the third sidewall panel 152 of the pet transport apparatus 100 may also include a third forward foldline 184 and a third aft foldline 186, as shown. The third forward foldline 184 may extend from proximate a juncture of the first edge 106 and the third edge 110 of the center panel 104 leftward toward the third left edge 158, as shown. The third aft foldline 186 may extend from proximate a juncture of the second edge 108 and the third edge 110 of the center panel 104 leftward toward the third left edge 158, as shown.

The fourth sidewall panel 166 may have a fourth forward foldline 188 and a fourth aft foldline 190, as shown. The fourth forward foldline 188 may extend from proximate a juncture of the first edge 106 and the fourth edge 112 of the center panel 104 rightward toward the fourth right edge 174, as shown. The fourth aft foldline 190 may extend from proximate a juncture of the second edge 108 and the fourth edge 112 of the center panel 104 rightward toward the fourth left edge 172, as shown.

Additionally, the third sidewall panel 152 of the pet transport apparatus 100 may include a forward third-panel corner 192 configured to provide an arcuate transition between the third forward edge 154 and the third left edge 158, as shown. An aft third-panel corner 194 of the third sidewall panel 152 may be configured to provide an arcuate transition between the third aft edge 156 and the third left edge 158, as shown.

The fourth sidewall panel 166 may include a forward fourth-panel corner 196 configured to provide an arcuate transition between the fourth forward edge 168 and the fourth right edge 174, as shown. The fourth sidewall panel 166 may include an aft fourth-panel corner 197 configured to provide an arcuate transition between the third aft edge 156 and the third left edge 158, as shown.

With specific reference to FIG. 6 and FIG. 7, the center panel 104 has a center outer face 260 and a center interior face 262, the first sidewall panel 124 has a first outer face 264 and a first interior face 266, the second sidewall panel 138 has a second outer face 268 and a second interior face 270, the third sidewall panel 152 has a third outer face 272 and a third interior face 276, and the fourth sidewall panel 166 has a fourth outer face 278 and a fourth interior face 280. The center interior face 262, the first interior face 266, the second interior face 270, the third interior face 276, and the fourth interior face 280 may each include resilient padding. It should be noted that the panels forming the apparatus may be supplied in various materials and sizes to accommodate the requirements of the pet and user needs.

The pet transport apparatus 100 may also include a first corner fastener 198 configured to releasably secure the third forward foldline 184 of the third sidewall panel 152 and along the first left edge 130 of the first sidewall panel 124. A second corner fastener 200 may be provided to releasably secure the third aft foldline 186 of the third sidewall panel 152 proximate and along the second left edge 144 of the second sidewall panel 138, as shown. A third corner fastener 202 may be provided to releasably secure the fourth forward foldline 188 of the fourth sidewall panel 166 proximate and along the first right edge 132 of the first sidewall panel 124, as shown. A fourth corner fastener 204 may be provided to releasably secure the fourth aft foldline 190 of the fourth sidewall panel 166 proximate and along the second right edge 146 of the second sidewall panel 138, as shown.

In one arrangement of the present disclosure, the first corner fastener 198 may consist of a first reclosable zipper having first interlockable zipper halves 208, as shown. The first interlockable zipper halves 208 may be joined with the third forward foldline 184 of the third sidewall panel 152 and the first left edge 130 of the first sidewall panel 124, respectively. The second corner fastener 200 may consist of a second reclosable zipper having second interlockable zipper halves 212, the second interlockable zipper halves 212 joined with the third aft foldline 186 of the third sidewall panel 152 and the second left edge 144 of the second sidewall panel 138, respectively. The third corner fastener 202 may consist of a third reclosable zipper having third interlockable zipper halves 216, the third interlockable zipper halves 216 joined with the fourth forward foldline 188 of the fourth sidewall panel 166 and the first right edge of the first sidewall panel 124, respectively. The fourth corner fastener 204 may consist of a fourth reclosable zipper having fourth interlockable zipper halves 220, the fourth interlockable zipper halves 220 joined with the fourth aft foldline 190 of the fourth sidewall panel 166 and the second right edge 146 of the second sidewall panel 138, respectively. In one version of the disclosure, the interlockable zipper halves extend substantially the entire length of their respective foldlines.

The pet transport apparatus 100 may also have a forward top panel 222 having a fifth forward edge 224, a fifth aft edge 226, a fifth left edge 228, and a fifth right edge 230, the fifth aft edge 226 extending from the first forward edge 126 of the first sidewall panel 124, as shown. The pet transport apparatus 100 may also have an aft top panel 232 having a sixth forward edge 234, a sixth aft edge 236, a sixth left edge 238, and a sixth right edge 240, the sixth forward edge 234 extending from the second aft edge 142 of the second sidewall panel 138, as shown.

The pet transport apparatus 100 may also include a top-panel fastener 242 configured to releasably secure the fifth forward edge 224 of the forward top panel 222 proximate and along the sixth aft edge 236 of the aft top panel. In one arrangement of the disclosure, the top-panel fastener 242 consists of a hook-and-loop fastener, as shown.

The pet transport apparatus 100 may also include a first carrying handle 244 and a second carrying handle 246, as shown. The carrying handles 243 of the apparatus may include a first carrying handle 244 and a second carrying handle 246 configured to assist carrying of the apparatus by the user 5. The first carrying handle 244 may include a pair of first handle ends 248 extending from the first forward edge 126 of the first sidewall panel 124, as shown. The a second carrying handle 246 may include a pair of second handle ends 250 extending from the second aft edge 142 of the second sidewall panel 138, as shown. At least one portion of the first carrying handle 244 is also fixed to the forward top panel 222 by stitching, bonding, or similar attachments, thus forming a first loop 252, as shown. Similarly, at least one portion of the second carrying handle 246 is fixed to the aft top panel to form a second loop 254, as shown. The shoulder strap 256 may include a set of releasable couplers 258 adapted to selectively couple the ends of the shoulder strap 256 to the first loops 252 or second loops 254, as shown.

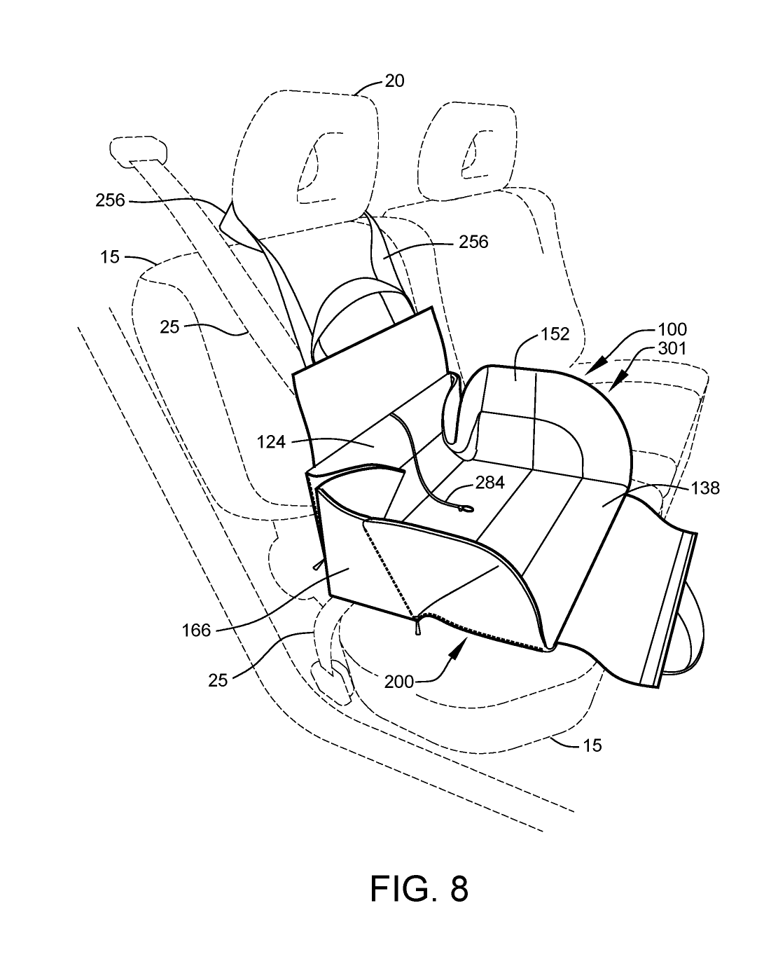

FIG. 8 is a perspective view of pet transport apparatus 100 of FIG. 1 during an alternate ‘in-use’ condition 301, according to an embodiment of the present disclosure. As illustrated, the shoulder strap 256 may be further adapted to restrain the apparatus in a position adjacent a vehicle seat 15 by releasable looped engagement with a headrest 20 of the vehicle seat 15, as shown. Also, at least one side panel of the set of side panels has been adjusted from the upright orientation to the collapsed orientation. This configuration allows the owner to view the pet and offers the pet additional freedom of movement.

Referring again to FIG. 1 through FIG. 8, the pet transport apparatus 100 may also have an external restraint loop 290 configured to restrain the apparatus in a position adjacent a vehicle seat 15 by releasable engagement with a seatbelt 25 of the vehicle seat 15. The external restraint loop 290 may be fixed to and extend from the second outer face 268 of the second sidewall panel 138, as shown. More specifically, the external restraint loop 290 may be sewn to a lower peripheral edge of the exterior pocket 288, as shown in FIG. 6.

The pet transport apparatus 100 may also have a pet-restraining leash 284 configured to restrain the pet 10 in a position adjacent the apparatus, as shown in FIG. 5. The pet-restraining leash 284 may extend from and be fixed to the second aft edge 142 of the second sidewall panel 138, as shown. The pet-restraining leash 284 may be configured to be extendable over at least one portion of the center interior face 262 of the center panel 104, as shown. The pet-restraining leash 284 may include a pet-collar connector 286 configured to be releasably connectable to the pet 10, as shown.

In one arrangement of the disclosure, the exterior pocket 288 is fixed to the second outer face 268 of the second sidewall panel 138, as shown, although in should be noted that pockets may be applied to any panel of the apparatus. The exterior pocket 288 may further include a zipper or other closure device to assist in retaining items in the pocket during transport.

As illustrated in FIG. 1, the first outer face of the first sidewall panel may include graphics (identified herein as indicia 298). The indicia 298 may include thematic images, printed messages, logos and branding, etc. It is noted that the indicia 298 may also be applied to other selected surface of the apparatus.

In one arrangement of the disclosure, the central interior face 262, the first interior face 266, the second interior face 270, the third interior face 276 and the fourth interior face 280 may consist of a single unitary sheet of a flexible sheet material.

The pet transport apparatus 100 may also be arranged as a kit 151 (see FIG. 1). In particular, the pet transport apparatus 100 may further include a set of instructions 107. The instructions 107 may detail functional relationships in relation to the structure of the pet transport apparatus 100 such that the pet transport apparatus 100 can be used, maintained, or the like, in a preferred manner.

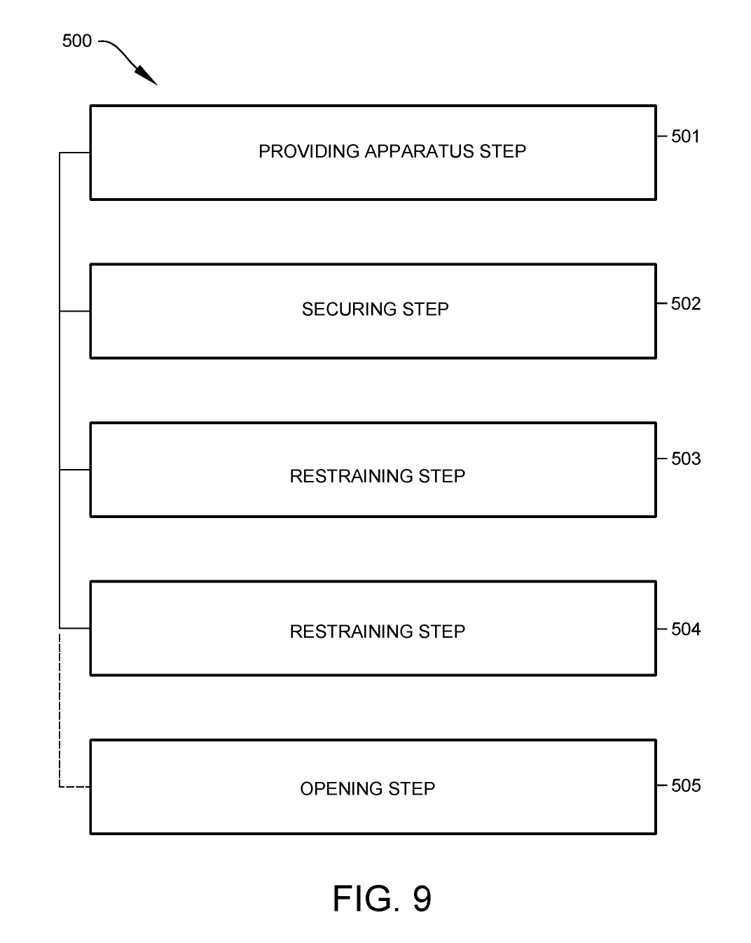

FIG. 9 is a flow diagram illustrating the steps in a method 500 of using the above-described apparatus for transporting a pet, according to an embodiment of the present disclosure. As illustrated, the method 500 may include the steps of: step one 501, providing the pet transport apparatus 100 of FIG. 1 through FIG. 8; step two 502, securing the pet in a position adjacent the apparatus using the pet-restraining leash; step three 503, restraining the apparatus in a position adjacent the vehicle seat by forming a looped engagement of the shoulder strap with a headrest of the vehicle seat; step four 504, restraining the apparatus in a position adjacent the vehicle seat by releasably engaging the seatbelt of the vehicle seat with the external restraint loop of the apparatus. The method 500 may further include step five 505, of opening at least one of the first sidewall panel, the second sidewall panel, the third sidewall panel, and the fourth sidewall panel from the first, second, third, and fourth upright orientations, respectively, into the first, second, third, or fourth collapsed orientations, respectively, during transport, as generally illustrated in FIG. 8.

It should be noted that step 504 is an optional step and may not be implemented in all cases. Optional steps of method 500 are illustrated using dotted lines in FIG. 8 so as to distinguish them from the other steps of method 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for pet transport apparatus 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An apparatus for transporting a pet, the apparatus comprising:
a center panel having four edges, said four edges having a first edge and a second edge opposite the first edge, and said four edges further having a third edge and a fourth edge opposite the third edge, the center panel defining a horizontal plane having a left direction corresponding to the third edge, a right direction corresponding to the fourth edge, a forward direction corresponding to the first edge, and an aft direction corresponding to the second edge;
a first sidewall panel having a first forward edge, a first aft edge, a first left edge, and a first right edge,
the first aft edge extending from the first edge of the center panel,
the first sidewall panel adapted to be movable between a first upright orientation and a first collapsed orientation;
a second sidewall panel having a second forward edge, a second aft edge, a second left edge, and a second right edge,
the second forward edge extending from the second edge of the center panel,
the second sidewall panel adapted to be movable between a second upright orientation and a second collapsed orientation;
a third sidewall panel having a third forward edge, a third aft edge, a third left edge, and a third right edge,
the third right edge extending from a combination of the third edge of the center panel, at least a portion of the first left edge of the first sidewall panel, and at least a portion of the second left edge of the second sidewall panel together,
the third sidewall panel adapted to be movable between a third upright orientation and a third collapsed orientation,
the third forward edge and the third aft edge each being configured to fold toward the center panel when the third sidewall panel is in the third upright orientation, respectively; and
a fourth sidewall panel having a fourth forward edge, a fourth aft edge, a fourth left edge, and a fourth right edge,
the fourth left edge extending from a combination of the fourth edge of the center panel, at least a portion of the first right edge of the first sidewall panel, and at least a portion of the second right edge of the second sidewall panel together,
the fourth sidewall panel adapted to be movable between a fourth upright orientation and a fourth collapsed orientation,
the fourth forward edge and the fourth aft edge each being configured to fold toward the center panel when the fourth sidewall panel is in the fourth upright orientation; and
wherein the center panel, the first sidewall panel, the second sidewall panel, the third sidewall panel, and the fourth sidewall panel together are configured to form a four-wall, semi-enclosed interior when the first sidewall panel, the second sidewall panel, the third sidewall panel, and the fourth sidewall panel are secured in the first, second, third, and fourth upright orientations, respectively; and
wherein the center panel, the first sidewall panel, the second sidewall panel, the third sidewall panel, and the fourth sidewall panel together are configured to form a substantially horizontal pad when the first sidewall panel, the second sidewall panel, the third sidewall panel, and the fourth sidewall panel are opened into the first, second, third, and fourth collapsed orientations, respectively.

2. The apparatus of claim 1, wherein the third sidewall panel also has a third forward foldline and a third aft foldline, the third forward foldline extending from proximate a juncture of the first edge and the third edge of the center panel leftward toward the third left edge, the third aft foldline extending from proximate a juncture of the second edge and the third edge of the center panel leftward toward the third left edge; and
wherein the fourth sidewall panel also has a fourth forward foldline and a fourth aft foldline, the fourth forward foldline extending from proximate a juncture of the first edge and the fourth edge of the center panel rightward toward the fourth right edge, the fourth aft foldline extending from proximate a juncture of the second edge and the fourth edge of the center panel rightward toward the fourth left edge.

3. The apparatus of claim 2, wherein the third sidewall panel also has a forward third-panel corner configured to provide an arcuate transition between the third forward edge and the third left edge, and an aft third-panel corner configured to provide an arcuate transition between the third aft edge and the third left edge; and
wherein the fourth sidewall panel also has a forward fourth-panel corner configured to provide an arcuate transition between the fourth forward edge and the fourth right edge, and an aft fourth-panel corner configured to provide an arcuate transition between the third aft edge and the third left edge.

4. The apparatus of claim 2, further comprising:
a first corner fastener configured to releasably secure the third forward foldline of the third sidewall panel proximate and along the first left edge of the first sidewall panel;
a second corner fastener configured to releasably secure the third aft foldline of the third sidewall panel proximate and along the second left edge of the second sidewall panel;
a third corner fastener configured to releasably secure the fourth forward foldline of the fourth sidewall panel proximate and along the first right edge of the first sidewall panel; and
a fourth corner fastener configured to releasably secure the fourth aft foldline of the fourth sidewall panel proximate and along the second right edge of the second sidewall panel.

5. The apparatus of claim 4, wherein the first corner fastener includes a first reclosable zipper having first interlockable zipper halves, the first interlockable zipper halves joined to the third forward foldline of the third sidewall panel proximate and the first left edge of the first sidewall panel, respectively;
wherein the second corner fastener includes a second reclosable zipper having second interlockable zipper halves, the second interlockable zipper halves joined to the third aft foldline of the third sidewall panel and the second left edge of the second sidewall panel, respectively;
wherein the third corner fastener includes a third reclosable zipper having third interlockable zipper halves, the third interlockable zipper halves joined to the fourth forward foldline of the fourth sidewall panel and the first right edge of the first sidewall panel, respectively; and
wherein the fourth corner fastener includes a fourth reclosable zipper having fourth interlockable zipper halves, the fourth interlockable zipper halves joined to the fourth aft foldline of the fourth sidewall panel and the second right edge of the second sidewall panel, respectively.

6. The apparatus of claim 1, wherein the apparatus is constructed from at least one flexible sheet material.

7. The apparatus of claim 1, further comprising:
a forward top panel having a fifth forward edge, a fifth aft edge, a fifth left edge, and a fifth right edge, the fifth aft edge extending from the first forward edge of the first sidewall panel;
an aft top panel having a sixth forward edge, a sixth aft edge, a sixth left edge, and a sixth right edge, the sixth forward edge extending from the second aft edge of the second sidewall panel; and
a top-panel fastener configured to releasably secure the fifth forward edge of the forward top panel proximate and along the sixth aft edge of the aft top panel.

8. The apparatus of claim 7, wherein the top-panel fastener includes a hook-and-loop fastener.

9. The apparatus of claim 7, further comprising:
a first carrying handle configured to assist carrying of the apparatus by a user, the first carrying handle having a pair of first handle ends fixed to and extending from the first forward edge of the first sidewall panel; and
a second carrying handle configured to assist carrying of the apparatus by the user, the second carrying handle having a pair of second handle ends fixed to and extending from the second aft edge of the second sidewall panel; and
wherein at least a portion of the first carrying handle is also fixed to the forward top panel; and
wherein at least a portion of the second carrying handle is also fixed to the aft top panel.

10. The apparatus of claim 1, further comprising a shoulder strap configured to assist in supporting the apparatus from a shoulder of the user.

11. The apparatus of claim 10, wherein the shoulder strap is further adapted to restrain the apparatus in a position adjacent to a vehicle seat by releasable looped engagement with a headrest of the vehicle seat.

12. The apparatus of claim 11, wherein the center panel has a center outer face and a center interior face, the first sidewall panel has a first outer face and a first interior face, the second sidewall panel has a second outer face and a second interior face, the third sidewall panel has a third outer face and a third interior face, and the fourth sidewall panel has a fourth outer face and a fourth interior face, each interior face corresponding to the four-wall, semi-enclosed interior; and
wherein the center interior face, the first interior face, the second interior face, the third interior face and the fourth interior face include a resilient padding.

13. The apparatus of claim 12, further comprising a pet-restraining leash configured to restrain a pet adjacent the apparatus, the pet-restraining leash fixed to and extending from the second aft edge of the second sidewall panel, the pet-restraining leash extendable over at least one portion of the center interior face of the center panel, and the pet-restraining leash including a pet-collar connector configured to be releasably connectable to the pet.

14. The apparatus of claim 12, further comprising at least one exterior pocket configured to hold user items, the at least one exterior pocket fixed to the second outer face of the second sidewall panel.

15. The apparatus of claim 12, further comprising an external restraint loop configured to restrain the apparatus in a position adjacent a vehicle seat by releasable engagement with a seatbelt of the vehicle seat; and
wherein the external restraint loop is fixed to and extends from the second outer face of the second sidewall panel.

16. The apparatus of claim 12, wherein the center interior face, the first interior face, the second interior face, the third interior face and the fourth interior face are combined as a single unitary sheet of a flexible material.

17. A convertible pet transport bag relating to the transport of at least one pet, said convertible pet transport bag comprising:
a center panel having four edges, said four edges having a first edge and a second edge opposite the first edge, and said four edges further having a third edge and a fourth edge opposite the third edge, the center panel defining a horizontal plane having a left direction corresponding to the third edge, a right direction corresponding to the fourth edge, a forward direction corresponding to the first edge, and an aft direction corresponding to the second edge;
a first sidewall panel having a first forward edge, a first aft edge, a first left edge, and a first right edge,
the first aft edge extending from the first edge of the center panel,
the first sidewall panel adapted to be movable between a first upright orientation and a first collapsed orientation;
a second sidewall panel having a second forward edge, a second aft edge, a second left edge, and a second right edge,
the second forward edge extending from the second edge of the center panel,
the second sidewall panel adapted to be movable between a second upright orientation and a second collapsed orientation;
a third sidewall panel having a third forward edge, a third aft edge, a third left edge, and a third right edge,
the third right edge extending from a combination of the third edge of the center panel, at least a portion of the first left edge of the first sidewall panel, and at least a portion of the second left edge of the second sidewall panel together,
the third sidewall panel adapted to be movable between a third upright orientation and a third collapsed orientation,
the third forward edge and the third aft edge each being configured to fold toward the center panel when the third sidewall panel is in the third upright orientation, respectively;
a fourth sidewall panel having a fourth forward edge, a fourth aft edge, a fourth left edge, and a fourth right edge,
the fourth left edge extending from a combination of the fourth edge of the center panel, at least a portion of the first right edge of the first sidewall panel, and at least a portion of the second right edge of the second sidewall panel together,
the fourth sidewall panel adapted to be movable between a fourth upright orientation and a fourth collapsed orientation,
the fourth forward edge and the fourth aft edge each being configured to fold toward the center panel when the fourth sidewall panel is in the fourth upright orientation; and
wherein the center panel, the first sidewall panel, the second sidewall panel, the third sidewall panel, and the fourth sidewall panel together are configured to form a four-wall, semi-enclosed interior when the first sidewall panel, the second sidewall panel, the third sidewall panel, and the fourth sidewall panel are secured in the first, second, third, and fourth upright orientations, respectively; and
wherein the center panel, the first sidewall panel, the second sidewall panel, the third sidewall panel, and the fourth sidewall panel together are configured to form a substantially horizontal pad when the first sidewall panel, the second sidewall panel, the third sidewall panel, and the fourth sidewall panel are opened into the first, second, third, and fourth collapsed orientations, respectively;
wherein the third sidewall panel also has a third forward foldline and a third aft foldline, the third forward foldline extending from proximate a juncture of the first edge and the third edge of the center panel leftward toward the third left edge, the third aft foldline extending from proximate a juncture of the second edge and the third edge of the center panel leftward toward the third left edge;
wherein the fourth sidewall panel also has a fourth forward foldline and a fourth aft foldline, the fourth forward foldline extending from proximate a juncture of the first edge and the fourth edge of the center panel rightward toward the fourth right edge, the fourth aft foldline extending from proximate a juncture of the second edge and the fourth edge of the center panel rightward toward the fourth left edge;
wherein the third sidewall panel also has a forward third-panel corner configured to provide an arcuate transition between the third forward edge and the third left edge, and an aft third-panel corner configured to provide an arcuate transition between the third aft edge and the third left edge; and
wherein the fourth sidewall panel also has a forward fourth-panel corner configured to provide an arcuate transition between the fourth forward edge and the fourth right edge, and an aft fourth-panel corner configured to provide an arcuate transition between the third aft edge and the third left edge; and
further comprising
a first corner fastener configured to releasably secure the third forward foldline of the third sidewall panel proximate and along the first left edge of the first sidewall panel;
a second corner fastener configured to releasably secure the third aft foldline of the third sidewall panel proximate and along the second left edge of the second sidewall panel;
a third corner fastener configured to releasably secure the fourth forward foldline of the fourth sidewall panel proximate and along the first right edge of the first sidewall panel; and
a fourth corner fastener configured to releasably secure the fourth aft foldline of the fourth sidewall panel proximate and along the second right edge of the second sidewall panel;
wherein the first corner fastener includes a first reclosable zipper having first interlockable zipper halves, the first interlockable zipper halves joined to the third forward foldline of the third sidewall panel proximate and the first left edge of the first sidewall panel, respectively;
wherein the second corner fastener includes a second reclosable zipper having second interlockable zipper halves, the second interlockable zipper halves joined to the third aft foldline of the third sidewall panel and the second left edge of the second sidewall panel, respectively;
wherein the third corner fastener includes a third reclosable zipper having third interlockable zipper halves, the third interlockable zipper halves joined to the fourth forward foldline of the fourth sidewall panel and the first right edge of the first sidewall panel, respectively; and
wherein the fourth corner fastener includes a fourth reclosable zipper having fourth interlockable zipper halves, the fourth interlockable zipper halves joined to the fourth aft foldline of the fourth sidewall panel and the second right edge of the second sidewall panel, respectively;
wherein the apparatus is constructed from at least one flexible sheet material; and
further comprising
a forward top panel having a fifth forward edge, a fifth aft edge, a fifth left edge, and a fifth right edge, the fifth aft edge extending from the first forward edge of the first sidewall panel;
an aft top panel having a sixth forward edge, a sixth aft edge, a sixth left edge, and a sixth right edge, the sixth forward edge extending from the second aft edge of the second sidewall panel; and
a top-panel fastener configured to releasably secure the fifth forward edge of the forward top panel proximate and along the sixth aft edge of the aft top panel;
wherein the top-panel fastener includes a hook-and-loop fastener; and
further comprising a first carrying handle configured to assist carrying of the apparatus by a user, the first carrying handle having a pair of first handle ends fixed to and extending from the first forward edge of the first sidewall panel; and
a second carrying handle configured to assist carrying of the apparatus by the user, the second carrying handle having a pair of second handle ends fixed to and extending from the second aft edge of the second sidewall panel; and
wherein at least a portion of the first carrying handle is also fixed to the forward top panel; and
wherein at least a portion of the second carrying handle is also fixed to the aft top panel; and
further comprising a shoulder strap configured to assist in supporting the apparatus from a shoulder of the user;
wherein the shoulder strap is further adapted to restrain the apparatus in a position adjacent to a vehicle seat by releasable looped engagement with a headrest of the vehicle seat;
wherein the center panel has a center outer face and a center interior face, the first sidewall panel has a first outer face and a first interior face, the second sidewall panel has a second outer face and a second interior face, the third sidewall panel has a third outer face and a third interior face, and the fourth sidewall panel has a fourth outer face and a fourth interior face, each interior face corresponding to the four-wall, semi-enclosed interior; and
wherein the center interior face, the first interior face, the second interior face, the third interior face and the fourth interior face include a resilient padding; and
further comprising a pet-restraining leash configured to restrain a pet adjacent the apparatus, the pet-restraining leash fixed to and extending from the second aft edge of the second sidewall panel, the pet-restraining leash extendable over at least one portion of the center interior face of the center panel, and the pet-restraining leash including a pet-collar connector configured to be releasably connectable to the pet; and
further comprising at least one exterior pocket configured to hold user items, the at least one exterior pocket fixed to the second outer face of the second sidewall panel; and
further comprising an external restraint loop configured to restrain the apparatus in a position adjacent a vehicle seat by releasable engagement with a seatbelt of the vehicle seat; and
wherein the external restraint loop is fixed to and extends from the second outer face of the second sidewall panel;
wherein the center interior face, the first interior face, the second interior face, the third interior face and the fourth interior face are combined as a single unitary sheet of a flexible material; and
wherein the first outer face of the first sidewall panel further includes indicia.

18. The convertible pet transport bag of claim 17, further comprising set of instructions; and
wherein the convertible pet transport bag is arranged as a kit.

19. A method of transporting a pet in a vehicle seat of a vehicle, the vehicle seat including a seatbelt, the method including the steps of:
providing the apparatus of claim 13;
securing the pet in a position adjacent the apparatus using the pet-restraining leash;
restraining the apparatus in a position adjacent the vehicle seat by forming a looped engagement of the shoulder strap with a headrest of the vehicle seat; and
restraining the apparatus in a position adjacent a vehicle seat by releasably engaging the seatbelt of the vehicle seat with the external restraint loop of the apparatus.

20. The method of claim 19, further comprising the step of opening at least one of the first sidewall panel, the second sidewall panel, the third sidewall panel, and the fourth sidewall panel from the first, second, third, and fourth upright orientations, respectively, into the first, second, third, or fourth collapsed orientations, respectively, during transport.
